(19) United States
(12) Patent Application Publication
(10) Pub. No.: US 2026/0370565 A1
(43) Pub. Date: Nov. 19, 2026

(54) DETERMINING AND CONFIGURING A MACHINE LEARNING MODEL PROFILE IN A WIRELESS COMMUNICATION NETWORK

(71) Applicant: Lenovo (Singapore) Pte. Ltd., Singapore (SG)

(72) Inventors: Konstantinos SAMDANIS, Munich (DE); Emmanouil PATEROMICHELAKIS, Viersen (DE); Dimitrios KARAMPATSIS, Ruislip (GB)

(21) Appl. No.: 19/143,201

(22) PCT Filed: Feb. 20, 2023
(86) PCT No.: PCT/EP2023/054161

§ 371 Date: Jun. 25, 2025

(30) Foreign Application Priority Data
Dec. 27, 2022 (GR) 20220101080

(51) Int. Cl. H04L 41/16; G06N 20/00; H04L 41/142; H04W 24/02; H04W 84/04

(52) U.S. Cl. CPC H04L 41/16; G06N 20/00; H04L 41/142; H04W 24/02; H04W 84/042

(57) ABSTRACT

There is provided a network entity in a wireless communication network, comprising: a processor; and a memory coupled with the processor. The processor is configured to cause the network entity to determine a first machine learning ‘ML’ model profile of a first ML model, wherein the first ML model has been trained using training data acquired from the wireless communication network when the wireless communication network was in a first particular network condition; the first ML model profile comprises at least one model characteristic of the first ML model; and the first ML model profile comprises at least one network condition parameter indicative of the first particular network condition.

### FIELD

The subject matter disclosed herein relates generally to the field of implementing the determining and configuring of a machine learning model profile in a wireless communication network. This document defines a network entity and method in a wireless communication network.

### INTRODUCTION

Network analytics and Artificial Intelligence (AI)/Machine learning (ML) is deployed in the 5G core network via the introduction of a Network Data Analytics Function (NWDAF). Various analytics types, that can be distinguished using different Analytics IDs, e.g., “UE Mobility”, “NF Load”, etc., may be supported. This is discussed in TS 23.288.

Each NWDAF may support one or more Analytics IDs and may have the role of implementing: (i) AI/ML inference, called NWDAF AnLF, or (ii) AI/ML training, called NWDAF MTLF, or (iii) both. AnLF that support a specific Analytics ID inference and subscribes to a corresponding MTLF that is responsible for training.

TS 23.288 introduces the Analytics Data Repository Function (ADRF) that supports storage and retrieval of analytics generated by NWDAFs and other collected data.

U.S. Pat. No. 10,572,321B2 describes a method for providing and retrieving listed repository items such as algorithms, data, models, pipelines, and/or notebooks. A consumer places a query using an application programming interface (API) to find and select shared content to build a ML pipeline and/or cause the execution or training of a selected ML model.

### SUMMARY

In TR 23.700-81, the ADRF storage and retrieval services are enhanced supporting ML models. In other words, it is proposed that the ADRF supports trained ML model(s) in the format of a file and/or file serialization to be stored by NF consumer i.e., NWDAF containing MTLF; and trained ML model(s) file retrieval by NF consumer i.e., NWDAF containing AnLF.

However, a gap currently remains in TS 23.288 related to ML Model ID. Bringing an algorithm ID and a network environmental conditions state identifier used during the training phase into the ML Model ID is one option, which may prove to expose ML model information, especially when it is used towards 3^{rd} party entities. An alternative approach however would be to introduce a serial number or string-based name and associate this to a ML Model profile.

An ML Model profile may comprise ML Model information, such as that provided in the TS 23.288, including one or more of the following parameters: identification of the location related to the ML model, e.g., NWDAF ID, ADRF ID; ML Model ID related to each historical ML model version stored (without being defined); analytics ID and model framework (i.e., analytics type); ML model implementation details, (e.g., model platform, model type, compilation language, etc.); ML model interoperability, (i.e., if the model retrieved can be used in the indicated platform or vendor); ML model deployment information including spatial validity, model validity period, accuracy, slice, target objects (e.g., UE(s), NF(s)) and other model content information as specified in clause 6.2A.2 TS 23.288; and notification end point that is expected to receive the ML model.

Furthermore, a ML Model profile may contain the network state (e.g., energy saving, network load, faults, etc.) to reflect the network conditions or network environment under which the ML Model was trained as well as the data sources to be able to reconstruct the ML pipeline. However a network state can relate to specific equipment, which may prove complex to use for certain cases where a ML model is needed across a greater geographical area where several network equipment is included. In addition, a detailed network state may not be appropriate to share with a 3^{rd} party since it reveals network internals.

This disclosure herein focuses on introducing a ML Model ID, which shall be unique across the entire public land mobile network (PLMN), and it is linked to a ML Model profile. The ID needs to be unique for ML Models used in a particular Analytics ID, which are trained under a similar network environment in terms of the network topology, (i.e., density, RAT used, etc.), traffic conditions, (i.e., load), service conditions (e.g., energy saving, faults) and user behavior (e.g., mobility, communication patterns, etc.). Hence there is a need to check and avoid storing the same ML Models in the ADRF under different identifiers. A ML Model shall also keep a training history, i.e., maintain a record of other ML Model(s), used as basis in the training process.

Disclosed herein are procedures for determining and configuring an ML model profile in a wireless communication network. Said procedures may be implemented by a network entity and a method in a wireless communication network.

There is provided, an a network entity in a wireless communication network, comprising: a processor; and a memory coupled with the processor, the processor configured to cause the network entity to: determine a first machine learning ‘ML’ model profile of a first ML model, wherein: the first ML model has been trained using training data acquired from the wireless communication network when the wireless communication network was in a first particular network condition; the first ML model profile comprises at least one model characteristic of the first ML model; and the first ML model profile comprises at least one network condition parameter indicative of the first particular network condition.

There is further provided, a network entity in a wireless communication network, comprising: a processor; and a memory coupled with the processor, the processor configured to cause the network entity to: store, in the memory, a plurality of ML model profiles of respective ML models, wherein: each respective ML model has been trained using training data acquired from the wireless communication network when the wireless communication network was in a respective particular network condition; each respective ML model profile comprises at least one model characteristic of the respective ML model; each respective ML model profile comprises at least one network condition parameter indicative of the respective particular network condition; wherein each respective ML model profile has an associated unique ML model identifier that can be used by a consumer to uniquely identify the respective ML model profile.

There is further provided, a method in a network entity, the network entity in a wireless communication network, comprising: determining a first machine learning ‘ML’ model profile of a first ML model, wherein: the first ML model has been trained using training data acquired from the wireless communication network when the wireless communication network was in a first particular network condition; the first ML model profile comprises at least one model characteristic of the first ML model; and the first ML model profile comprises at least one network condition indicative of the first particular network condition.

There is further provided, a method in a network entity, the network entity in a wireless communication network, comprising: storing a plurality of ML model profiles of respective ML models, wherein: each respective ML model has been trained using training data acquired from the wireless communication network when the wireless communication network was in a respective particular network condition; each respective ML model profile comprises at least one model characteristic of the respective ML model; each respective ML model profile comprises at least one network condition parameter indicative of the respective particular network condition; wherein each respective ML model profile has an associated unique ML model identifier that can be used by a consumer to uniquely identify the respective ML model profile.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for determining and configuring an ML model profile in a wireless communication network will now be described, by way of example only, with reference to the accompanying drawings, in which:

FIG. 1 illustrates an embodiment of a wireless communication network;

FIG. 2 illustrates an embodiment of a user equipment apparatus;

FIG. 3 illustrates an embodiment of a network node or network entity;

FIG. 4 illustrates an overview of NWDAF flavors, input data sources and output consumers;

FIG. 5 illustrates an embodiment of a data storage architecture for analytics and collected data;

FIG. 6 illustrates an embodiment of a method in a wireless communication network;

FIG. 7 illustrates an embodiment of an alternative method in a wireless communication network; and

FIG. 8 illustrates an embodiment of ML model creation and storage.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

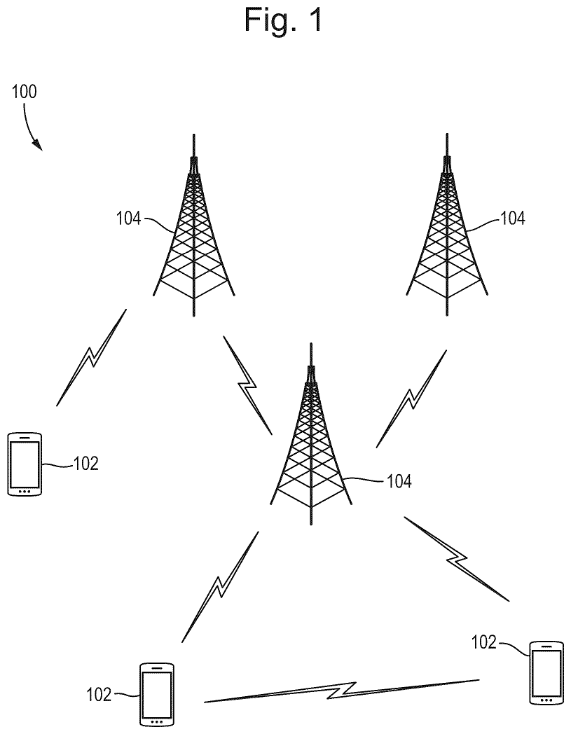

FIG. 1 depicts an embodiment of a wireless communication system 100 for determining and configuring a machine learning model profile in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

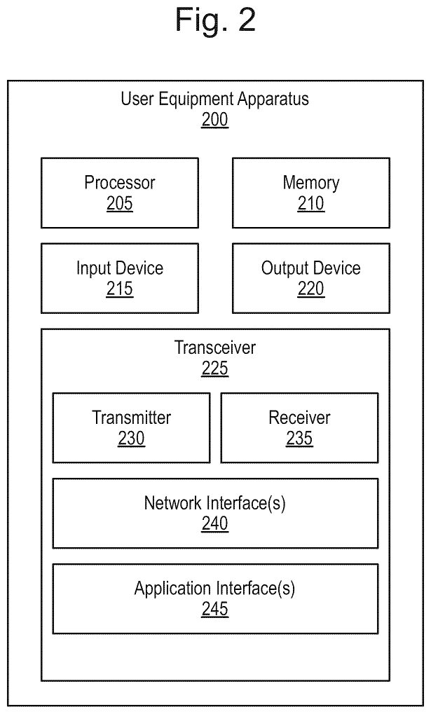

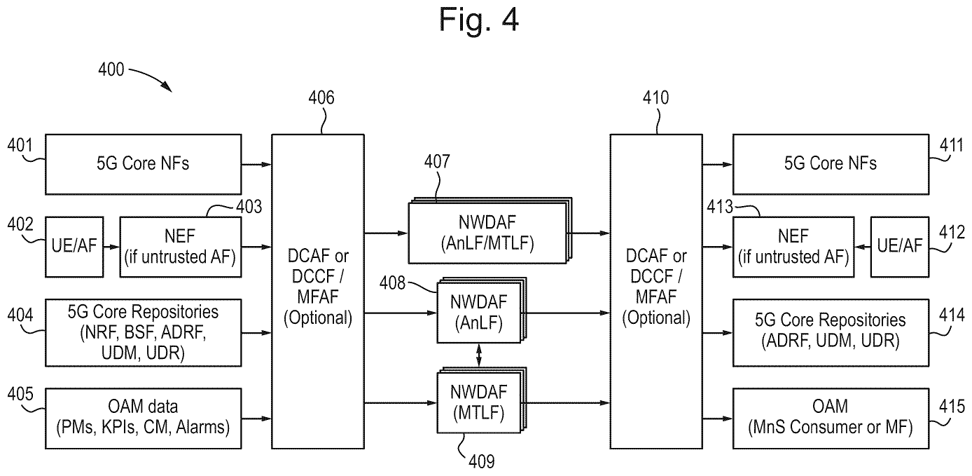

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a UE 102 of FIG. 1, a UE 402 or 412 of FIG. 4, for instance. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

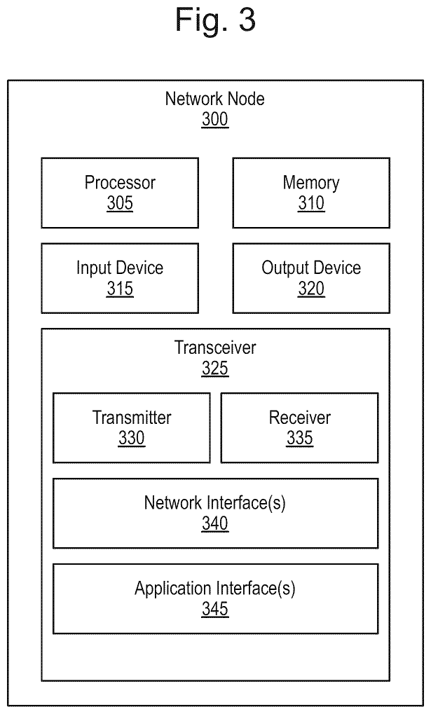

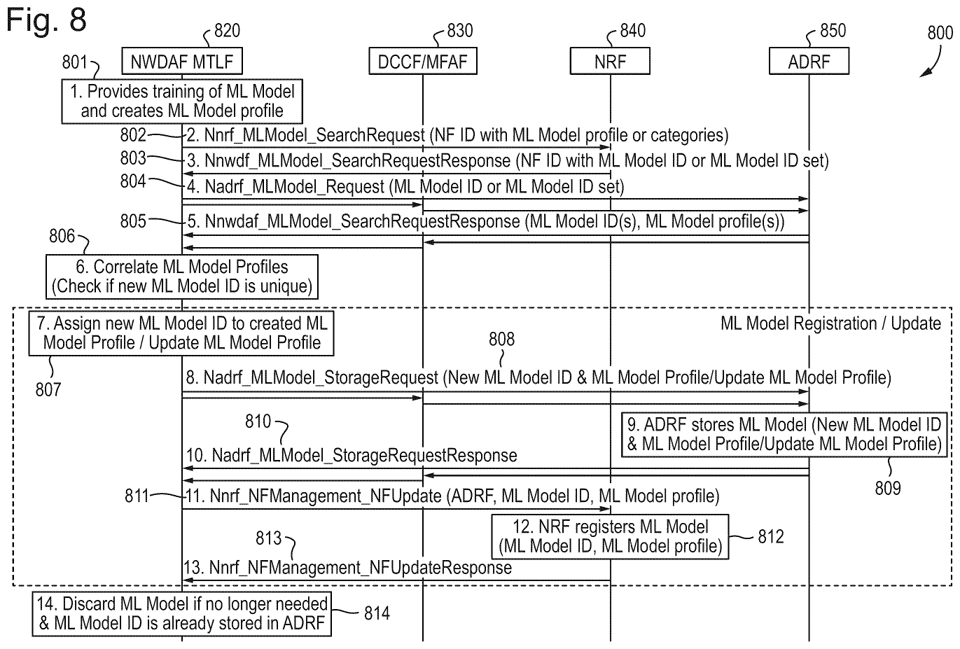

FIG. 3 depicts further details of the network node 300 that may be used for implementing the methods described herein. The network node 300 may be one implementation of an entity in the wireless communication network, e.g., in one or more of the wireless communication networks described herein. The network node 300 may comprise a NWDAF MTLF 820, a DCCF/MFAF 830, an NRF 840 or an ADRF 850 of FIG. 8, for instance. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

FIG. 4 illustrates an overview 400 of NWDAF flavors in addition to input data sources and output consumers. Input sources are shown as comprising 5G core NFs 401, UE/AF 402 (plus NEF 403 if AF 402 is untrusted), 5G core repositories 404 (NRF, BSF, ADRF, UDM, UDR) and OAM data 405 (PMs, KPIs, CM, Alarms). These input sources are illustrated as providing input to a DCAF or DCCF/MFAF 406 (optional). The DCAF or DCCF/MFAF 406 is illustrated as inputting to an NWDAF (AnLF/MTLF) 407, an NWDAF (AnLF) 408 and an NWDAF (MTLF) 409. The NWDAF (AnLF) 408 and NWDAF (MTLF) 409 are shown inputting and outputting to each other. The NWDAFs 407-409 are illustrated as providing outputs to a further DCAF or DCCF/MFAF 410 (optional) on an output consumer side of the figure. The DCAF or DCCF/MFAF 410 outputs to any of 5G core NFs 411, UE/AF 412 (via NEF 413 if AF 412 is untrusted), 5G core repositories 414 (ADRF, UDM, UDR) and OAM 415 (MnS consumer or MF).

More specifically, FIG. 4 illustrates the various NWDAF flavors and their respective input data and output result consumers, which may include 5G core NFs 401 and 411, AFs 402 and 412, 5G core repositories 404 and 414, e.g., NRF, UDM, etc., and the OAM (MnS Consumer or MF). MTLF 409 and AnLF 408 may exchange AI/ML models, e.g., via the means of serialization or containerization. Optionally, DCCF and MFAF may be involved to distribute and collect repeated data towards or from various data sources.

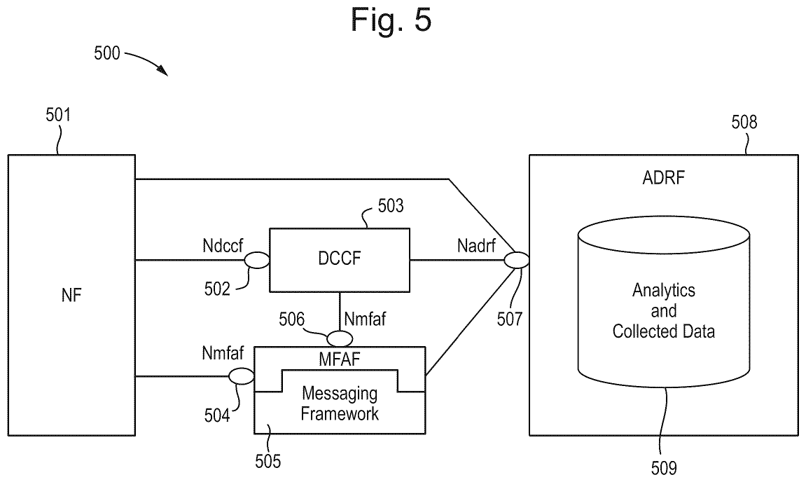

FIG. 5 illustrates an embodiment 500 of a data storage architecture for analytics and collected data. The figure illustrates an NF 501 connected to a DCCF 503 via Ndccf 502. The NF 501 also connects to MFAF messaging framework 505 via Nmfaf 504. The DCCF 503 and MFAF messaging framework 505 are shown connected via Nmfaf 506. All of NF 501, DCCF 503 and MFAF messaging framework 505 connect to an ADRF 508 via Nadrf 507. The ADRF 508 is shown comprising analytics and collected data 509.

More specifically, the options supported in 5G by architecture 500 include ADRF 508 provides storage and retrieval of data by other 5GC NFs 501 (e.g., NWDAF).

Based on the NF request or configuration on the DCCF 503, the DCCF 503 may determine the ADRF 508 and interact directly or indirectly with the ADRF 508 to request or store data. The interaction can be direct: the DCCF 503 requests to store data in the ADRF 508, or via a notification (e.g., when ADRF 508 requested data collection notification via DCCF 503). In addition, the DCCF 503 retrieves data from the ADRF 508. The interaction can also be indirect: the DCCF 503 requests the Messaging Framework 505 to store data in the ADRF 508. The Messaging Framework 505 may contain one or more adaptors that translate between 3GPP defined protocols.

A Consumer NF 501 may specify in requests to a DCCF 503 that data provided by a data source needs to be stored in the ADRF 508.

The ADRF 508 stores data received directly from an NF 501, or data received in a notify message from the DCCF 503, MFAF 505 or from the NWDAF.

The ADRF 508 checks if the data consumer is authorized to access ADRF services and provides the requested data using the procedures specified in TS 23.501 clause 7.1.4.

The proposed invention disclosed herein, relates to an apparatus and method that introduces for an ML model, a ML Model ID that is unique and an associated ML model profile that describes the training conditions of the ML model. This invention provides the ML model profile and enhances the profile with network state information/conditions by providing new parameters and by abstracting the notion of network topology, connectivity, energy saving and network faults to be applied to a given geographical area, e.g., named area of interest, instead of considering the configuration state of specific network equipment and network objects.

In this way the number of ML models with a similar ML model profiles stored in an ADRF or other repository is reduced, (i.e., a manageable number of ML Models are stored). ML Models can then be used and re-trained in similar network conditions, being able to be validated and generalized, i.e., being able to work well across similar conditions. In addition, the ML Model profile can be shared with 3^{rd} parties to assist the process of ML Model selection, since it does not contain network internal specifics.

An ML model in machine learning is created by an ML algorithm. In other words, an ML algorithm specifies a procedure, e.g., pattern recognition, that runs considering data (i.e., training data) to create an ML model. Certain terminology and processes in machine learning relevant to the disclosure herein shall now be briefly described.

An ML model can be a mathematical representation of a real-world process. To generate an ML model, one needs to provide training data to an ML algorithm to learn from. An ML model can then be used for ML inference or simply inference.

ML inference is a process where an ML model is fed with observation data, (i.e., data from where the ML model operates), and calculates an output result. This process is commonly referred to as “operationalizing a machine learning model” or “putting a machine learning model into production”.

An ML algorithm is the hypothesis set that is taken at the beginning before the training starts with real-world data. For instance, a hypothesis set considering a Linear Regression algorithm means a set of functions that share the characteristics defined by Linear Regression. From those set of functions, an ML model is the selected function that fits best the training data.

ML training is a process where an ML algorithm is fed with training data to find patterns such that the input parameters correspond to the target. The output of the training process is an ML model, which can be used to provide analytics results. This process is also referred to as “learning”.

More than one ML model may be available to choose for a specific Analytics ID. Each ML model needs to carry a unique identifier. The ML model ID needs also to be associated with the corresponding ML model profile. A unique ML model ID shall be assigned either by the NWDAF containing MTLF that provided the training of the ML Model and then verified that is unique, or can be assigned by another logical function that keeps track of the ML Model ID numbers or names.

A unique ML Model ID shall be assigned for a different ML Model profile also reflecting the history of previous ML models used in the process. Not all ML Models produced are worth storing or maintaining in an ADRF or other repository, but moreover only the ones commonly used, i.e., considering the popularity, the ones for a certain pre-determined time duration, and the ones that generalized well and do not face a significant performance drift considering the results of validation and testing.

Currently, ML Model selection procedures are unclear since the semantics of an ML Model profile are not defined. The ML Model profile for a specific area of interest as disclosed herein may contain one or more of a number of attributes, as will now be described.

The ML model profile may contain attributes relating to (transfer) learning characteristics. Transfer learning may be related to an experience gain from ML model training under a first network condition to second network condition (that is similar) and/or related to an experience gain from ML model training for a first Analytics ID or Event ID to a second Analytics ID or Event ID (that is similar based on a preconfigured arrangement). Such characteristics are related to analytics types such as NWDAF Analytics ID or Event ID, i.e., analytics type, which used and trained ML Model; and NWDAF other Analytics IDs or Event IDs that may benefit for using the ML Model.

The ML model profile may contain attributes relating to AI/ML Algorithm or set of AI/ML algorithms (i.e., in case of multi-algorithm adoption, e.g., for ensemble learning) used to produce or train the ML Model.

The ML model profile may contain attributes relating to network environment or network configuration or network context abstraction in the geographical area that may contain additional data sources used for training (e.g., in the area of interest).

Such information may be obtained via the OAM, and may include, but is not limited to network topology, i.e., topology abstraction, in terms of: radio density, number of radio access points per area of interest (e.g., low, medium, high); RAT percentage, (e.g., WiFi, ORAN nodes, 5G, etc.), among the radio access points per area of interest; network graph that captures the connectivity towards the core network. The type of graph G (N, E), e.g., star, tree, mesh, etc., with N nodes and E links and a set of weights reflecting the average or min/max, etc. KPI for all links, etc. Various KPIs may be considered such as, e.g., link capacity, latency, jitter, throughput, etc. The connectivity properties of a graph to capture average number of neighbors and network centrality, e.g., edge may be considered. The backhaul type (e.g., IP, Ethernet, etc.), and percentage of backhaul types may be considered.

The attributes relating to network environment/configuration/context may include network services configured, in terms of the slice type and average resource percentage per slice, (e.g., eMBB, mIoT, URLLC, V2X, etc.), as well as per DNN.

The attributes relating to network environment/configuration/context may include average load characterized as, e.g., high, medium, low, or any other plurality of load conditions.

The attributes relating to network environment/configuration/context may include the number and types of UEs, (e.g., users, MICO, vehicular, etc). These attributes may consider the percentage of active and passive; percentage of PDU session types and average communication activity; mobility type (e.g., vehicular, pedestrian, non-mobile), percentage of UEs in each mobility type and average mobility rate (e.g., average number of handovers); average application types and average application type percentage.

The attributes relating to network environment/configuration/context may include average energy saving conditions, e.g., peak, or off-peak and/or fault percentage of network equipment and severity of fault (e.g., out of use percentage).

The ML model profiles may comprise further attributes relating to the time when the ML Model training took place that can serve as a reference to the network environment or network context; and/or pointer to a database that stores network context and/or network configuration and/or other network trace information.

The ML model profiles may comprise attributes relating to the data used for ML model training, such as data version, reference to the data set used to train the model; data statistics, intervals, range and volume of data, time and frequency of data occurrence, data distribution type (e.g., linear, categorical, etc.); and NF ID that produced the data used in the training process.

The ML model profiles may comprise attributes relating to ML Model characteristics, obtained by the NWDAF either in the training phase or provided by the respective AnLF from the inference experience. These may include: ML model pipeline; components (e.g., data source, data preprocessing and distribution); component deployment recommendations (e.g., at network edge, transport, etc.); specific KPIs (i.e., average value) related to the usage of a ML Model by certain Analytics ID(s), e.g., average latency, throughput, etc; performance drift metrics and limits where re-training is recommended; learning curve, i.e., how much data is needed to achieve certain accuracy level (helps decide when to stop or continue training); predictions to help understand the ML model expected performance; sample of or pointer to collect validation/testing data (for checking if the new ML Model can also serve the purpose of the previous one).

The ML model profiles may comprise attributes relating to hardware characteristics for ML Model training and inference, which may include one or more of the following: minimum CPU, RAM and storage needed to train and inference/validate/test ML Model; minimum energy expenditure needed for ML model for training and inference; average speed for ML Model training and inference.

The ML model profiles may comprise attributes relating to interoperability in terms of hardware, software, platform, and vendor information (e.g., vendor ID, MTLF ID).

The ML model profiles may comprise attributes relating to a version of the ML model that reflects the history or evolution of the ML model. The version may document previous ML Models used as basis for further ML Model training. The version may document previous (and potentially different) network environment or configurations used in the process of ML Model training.

The current ML model info attributes listed in clause 6.2A.2 of 3GPP TS 23.288 are not sufficient. A ML Model ID and a respective profile can help the NWDAF (both AnLF and MTLF) to choose the most relevant ML model. The ML Model ID can be a serial number or string assigned by the MTLF without necessarily containing the MTLF NF Instance ID as suggested in clause 6.1 TR 23-700-81, since a respective ML Model ID relates to a ML Model profile and not to the MTLF that provided the training. A ML Model is only relevant to the conditions of the training reflected in the ML Model profile. The same conditions can be met in different MTLFs leading to the same ML Model, which needs to carry a unique ID valid in a PLMN. Hence the MTLF semantics shall be avoided from the ML Model ID.

Once the MTLF assigns a new ML Model ID, it needs to validate that it is unique, an activity that can be carried out either by MTLF with the assistance of ADRF (responsible for maintaining and/or storing the ML Model ID and the corresponding ML Model profile) or another network entity responsible for the ML Model ID validation with the assistance of ADRF.

It shall be noted that the ML profile attributes are determined by the NWDAF MTLF and OAM. Specifically, the MTLF that provided the training may include information related to one or more of the following attributes: transfer learning, AI/ML algorithm, time, data used for ML Model training, ML Model characteristics, hardware characteristics as well as interoperability and version information. The OAM can provide network environment and/or network configuration information either using configuration management procedures as per 3GPP TS 23.514, performance measurements as per 3GPP TS 28.552 and KPIs as per 3GPP TS 23.554, fault information and/or other data derived via trace tools related to MDT and other network wide measurements. The coordination for creating ML Model profile can be performed by the MTLF that trained the ML model or by another function or logical function responsible for this ML Model profile creation and maintenance.

The MTLF that trained the ML Model needs to coordinate and create the associated ML profile. Alternatively, the entity responsible for the creation of the ML Model profile would need to carry out this task. In both cases, there is a need to check whether the ML Model profile is new and does not exist in the ADRF, before assigning a new unique Model ID. Otherwise, it may update the profile of an already existing ML Model ID.

To be able to discover a ML Model profile, the process shall be able to search into either its contents, i.e., into the information carried by its attributes, and/or consider a pre-arranged categorization to group different ML Model profiles. Such categories can be established considering as criteria the AI/ML algorithm used, Analytics ID(s), time instance, certain conditions of the network environment, e.g., load, peak/off-peak, rural/urban deployment, etc.

The service processes used related to the ML Model storage, registration, search, and provision may include the following: ML Model storage towards the ADRF that shall include the ML Model ID and ML Model profile; ML Model registration in the DCCF/MFAF or NRF that shall include the NF ID that contains the ML Model ID and ML Model profile; ML Model search in the NRF for NF IDs (e.g., ADRF IDs) that shall include the ML Model ID and ML Model profile; ML Model provision towards the ML Model consumer that can be the NWDAF AnLF or NWDAF MTLF that shall the ML Model ID and ML Model profile.

Once a new ML Model is created at MLTF the proposed solution can enhance the ML model provision from ADRF by introducing the ML Model profile to complement the existing services. In this proposal an NRF may also contain logic about the ML model capability, to complement and/or enhance the NF capability. This would be a new functionality of the NRF that may be supported.

Hence, the disclosure herein provides for a network entity in a wireless communication network, comprising: a processor; and a memory coupled with the processor, the processor configured to cause the network entity to: determine a first machine learning ‘ML’ model profile of a first ML model, wherein: the first ML model has been trained using training data acquired from the wireless communication network when the wireless communication network was in a first particular network condition; the first ML model profile comprises at least one model characteristic of the first ML model; and the first ML model profile comprises at least one network condition parameter indicative of the first particular network condition.

In some embodiments the processor is further configured to cause the network entity to: determine whether the first ML model profile is a new ML model profile of the wireless communication network; and generate a unique first ML model identifier associated with the first ML model profile, based on a determination that the first ML model profile is a new ML model profile.

In some embodiments, the processor is configured to cause the network entity to determine whether the first ML model profile is a new ML model profile, by causing the network entity to: retrieve from a second network entity, at least a second ML model profile having an associated second ML model identifier, wherein: the second ML model has been trained using training data acquired from the wireless communication network when the wireless communication network was in a second particular network condition; the second ML model profile comprises at least one model characteristic of the second ML model; and the second ML model profile comprises at least one network condition parameter indicative of the second particular network condition; and then to compare the first ML model profile to the second ML model profile to determine a resemblance. The comparison may itself be a correlation.

In some embodiments, the second network entity is a network entity selected from the list of network entities consisting of: an analytical data repository function ‘ADRF’; a data repository function; a ML repository function; and another logical function.

In some embodiments, the processor is further configured, in causing the network entity to compare the first ML model profile to the second ML model profile, based on a given, i.e. pre-configured, resemblance factor.

In some embodiments, the resemblance factor comprises the degree of similarity among attributes of the first and second ML models, preferably the degree of similarity of: a quantity of said attributes; and/or a mean absolute deviation of one or more of the attributes of the first ML model from the corresponding one of more attributes of the second ML model.

In some embodiments, the processor is further configured to cause the network entity to: determine a high resemblance when the resemblance factor satisfies a first predetermined resemblance criterion; and determine a low resemblance and that the first ML model profile is new, when the resemblance factor does not satisfy the first predetermined resemblance criterion. The resemblance factor not satisfying the first predetermined resemblance criterion, may be considered equivalent to the resemblance factor satisfying a second predetermined resemblance criterion.

In some embodiments the processor is further configured to cause the network entity, having determined a high resemblance, to: retrieve validation data related to the second ML model profile; and determine whether the first ML model generalizes to the validation data, by applying the validation data to the first ML model.

In some embodiments, the processor is further configured to cause the network entity to: update the second ML model profile if it is determined that the first ML model generalizes to the validation data.

In some embodiments, the processor is further configured to cause the network entity to: transmit a storage request to the second network entity, the storage request comprising either: the first ML model identifier and first ML model profile, where the first ML model profile has been determined to be new; or the second ML model identifier and the updated second ML model profile, where the high resemblance has been determined.

In some embodiments, the processor is further configured, in causing the network entity to retrieve from the second network entity the at least a second ML model profile having an associated second ML model identifier, to cause the network entity to: transmit a search request to a repository or network repository function, the search request comprising a request for a network entity having an ML model profile matching the first ML model profile or having a requested ML model profile category;

receive a search response from the repository or network repository function, the search response comprising either: a network entity identifier of the second network entity wherein the second network entity has ML model profiles matching the first ML model profile, the search response further comprising ML model identifiers associated with the matched ML model profiles; or a network entity identifier of the second network entity wherein the second network entity has the requested ML model profile category, the search response further comprising an ML model profile set identifier; transmit to the second network entity, a request for the at least a second ML model profile, the request comprising the ML model identifiers or ML model profile set identifier; and receive from the second network entity, the at least a second ML model profile and associated ML model identifiers.

In some embodiments, the processor is further configured to cause the network entity to: train the first ML model; and determine the first ML model profile based at least on information collected or determined during the training.

In some embodiments, the processor is further configured to cause the network entity to: determine the first ML model profile based at least on information retrieved from an operations, administration and maintenance ‘OAM’ function.

In some embodiments, the first ML model profile comprises one or more characteristic selected from the list of characteristics consisting of: a learning characteristic relating to analytics types; an algorithm type used to produce or train the first ML model; a network environment, network configuration, or network abstraction, for a geographical area containing data sources used in a training of the first ML model; a training time or schedule of training of the first ML model; a training data used in a training of the first ML model; a model characteristic of the first ML model; an operating hardware of the first ML model; an interoperability characteristic of the first ML model; and a version characteristic or evolution history of the first ML model.

In some embodiments, the interoperability characteristic comprises one or more of: a hardware interoperability characteristic; a software interoperability characteristic; a vendor platform interoperability characteristic; and a vendor information interoperability characteristic.

In some embodiments, the at least one network condition parameter is abstracted away from network information internals of the wireless communication network.

In some embodiments, the network entity is a model training logical function ‘MTLF’.

In some embodiments, the wireless communication network is a public land mobile network ‘PLMN’.

In some embodiments, the processor is further configured to cause the network entity to register the first ML model profile and first ML model identifier with a NF in the NRF. In particular, this registration may occur where the first ML model profile is a new ML model profile to a PLMN. An NRF may provide NF specific ML model profile type or category information, and hence the network entity may provide an update thereto, for instance with respect to an ADRF ID or repository NF ID related to the first ML model identifier and first ML model profile. This is then stored in the NRF.

In some embodiments, a plurality of ML model profiles are determined/created to support different usage and deployment requirements.

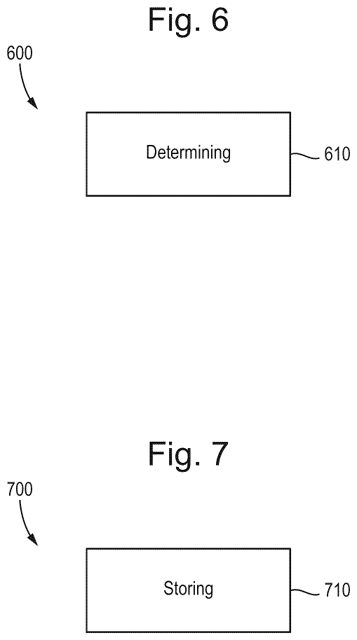

FIG. 6 illustrates an embodiment 600 of a method in a wireless communication network. The method 600 comprises determining 610 a first machine learning ‘ML’ model profile of a first ML model, wherein: the first ML model has been trained using training data acquired from the wireless communication network when the wireless communication network was in a first particular network condition; the first ML model profile comprises at least one model characteristic of the first ML model; and the first ML model profile comprises at least one network condition indicative of the first particular network condition. In certain embodiments, the method 600 may be performed by a processor executing program code, for example, a microcontroller, a microprocessor, a CPU, a GPU, an auxiliary processing unit, a FPGA, or the like.

Some embodiments comprise determining whether the first ML model profile is a new ML model profile of the wireless communication network; and generating a unique first ML model identifier associated with the first ML model profile, based on a determination that the first ML model profile is a new ML model profile.

Some embodiments comprise determining whether the first ML model profile is a new ML model profile, by: retrieving from a second network entity, at least a second ML model profile having an associated second ML model identifier, wherein: the second ML model has been trained using training data acquired from the wireless communication network when the wireless communication network was in a second particular network condition; the second ML model profile comprises at least one model characteristic of the second ML model; and the second ML model profile comprises at least one network condition parameter indicative of the second particular network condition; and then comparing the first ML model profile to the second ML model profile to determine a resemblance. The comparison may itself be a correlation.

In some embodiments, the second network entity is a network entity selected from the list of network entities consisting of: an analytical data repository function ‘ADRF’; a data repository function; a ML repository function; and another logical function.

In some embodiments the comparison of the first ML model profile to the second ML model profile, is based on a given, i.e., preconfigured, resemblance factor.

In some embodiments, the resemblance factor comprises the degree of similarity among attributes of the first and second ML models, preferably the degree of similarity of: a quantity of said attributes; and/or a mean absolute deviation of one or more of the attributes of the first ML model from the corresponding one of more attributes of the second ML model.

Some embodiments comprise determining a high resemblance when the resemblance factor satisfies a first predetermined resemblance criterion; and determining a low resemblance and that the first ML model profile is new, when the resemblance factor does not satisfy the first predetermined resemblance criterion. The resemblance factor not satisfying the first predetermined resemblance criterion, may be considered equivalent to the resemblance factor satisfying a second predetermined resemblance criterion.

Some embodiments, after determining a high resemblance, further comprise retrieving validation data related to the second ML model profile; and determining whether the first ML model generalizes to the validation data, by applying the validation data to the first ML model.

Some embodiments comprise updating the second ML model profile if the determining whether first ML model generalizes, determines that the first ML model generalizes to the validation data.

Some embodiments further comprises transmitting a storage request to the second network entity, the storage request comprising either: the first ML model identifier and first ML model profile, where the first ML model profile has been determined to be new; or the second ML model identifier and the updated second ML model profile, where a high resemblance has been determined.

In some embodiments, the retrieving from the second network entity the at least a second ML model profile having an associated second ML model identifier, comprises: transmitting a search request to a repository or network repository function, the search request comprising a request for a network entity having an ML model profile matching the first ML model profile or having a requested ML model profile category;

receiving a search response from the repository or network repository function, the search response comprising either: a network entity identifier of the second network entity wherein the second network entity has ML model profiles matching the first ML model profile, the search response further comprising ML model identifiers associated with the matched ML model profiles; or a network entity identifier of the second network entity wherein the second network entity has the requested ML model profile category, the search response further comprising an ML model profile set identifier; transmitting to the second network entity, a request for the at least a second ML model profile, the request comprising the ML model identifiers or ML model profile set identifier; and receiving from the second network entity, the at least a second ML model profile and associated ML model identifiers.

Some embodiments comprise training the first ML model; and determining the first ML model profile based at least on information collected or determined during the training.

Some embodiments comprise determining the first ML model profile based at least on information retrieved from an operations, administration and maintenance ‘OAM’ function.

In some embodiments, the first ML model profile comprises one or more characteristic selected from the list of characteristics consisting of: a learning characteristic relating to analytics types; an algorithm type used to produce or train the first ML model; a network environment, network configuration, or network abstraction, for a geographical area containing data sources used in a training of the first ML model; a training time or schedule of training of the first ML model; a training data used in a training of the first ML model; a model characteristic of the first ML model; an operating hardware of the first ML model; an interoperability characteristic of the first ML model; and a version characteristic or evolution history of the first ML model.

In some embodiments, the interoperability characteristic comprises one or more of: a hardware interoperability characteristic; a software interoperability characteristic; a vendor platform interoperability characteristic; and a vendor information interoperability characteristic.

In some embodiments, the at least one network condition parameter is abstracted away from network information internals of the wireless communication network.

In some embodiments, the network entity is a model training logical function ‘MTLF’.

In some embodiments, the wireless communication network is a public land mobile network ‘PLMN’.

Some embodiments comprise registering the first ML model profile and first ML model identifier with a NF in the NRF. In particular, this registration may occur where the first ML model profile is a new ML model profile to a PLMN. An NRF may provide NF specific ML model profile type or category information, and hence the network entity may provide an update thereto, for instance with respect to an ADRF ID or repository NF ID related to the first ML model identifier and first ML model profile. This is then stored in the NRF.

Some embodiments comprising determining/creating a plurality of ML model profiles to support different usage and deployment requirements.

The disclosure herein also provides for an alternative, network entity, in a wireless communication network, comprising a processor; and a memory coupled with the processor, the processor configured to cause the network entity to: store, in the memory, a plurality of ML model profiles of respective ML models, wherein: each respective ML model has been trained using training data acquired from the wireless communication network when the wireless communication network was in a respective particular network condition; each respective ML model profile comprises at least one model characteristic of the respective ML model; each respective ML model profile comprises at least one network condition parameter indicative of the respective particular network condition; wherein each respective ML model profile has an associated unique ML model identifier that can be used by a consumer to uniquely identify the respective ML model profile.

In some embodiments, the processor is further configured to cause the network entity to: receive, from the consumer, a request for a required ML model profile model, the request comprising: an ML model identifier, an ML model profile, and/or an ML model category; obtain, from the memory, the required ML model and associated ML model profile having the ML model identifier, ML model profile and/or ML model category; and transmit, to the consumer, the required ML model and ML model profile.

The requests that may originate from an MTLF as a consumer of ML model profiles, or another consumer of ML models and/or ML model profiles.

In some embodiments, the processor is further configured to cause the network entity to: receive, from the consumer, a storage request, the storage request comprising either a new ML model profile and an associated model identifier, or, an updated ML model profile and associated ML model identifier; and update, based on the storage request, the plurality of ML model profiles with either the new ML model profile and model identifier, or with the updated model profile and associated model identifier.

In some embodiments, the processor is further configured to cause the network entity to: delete, from the plurality of ML model profiles in the memory, an ML model profile and respective ML model identifier, when the ML model profile is identified as outdated.

In some embodiments, an ML model profile is identified as outdated when the processor causes the network entity to determine that either: a predetermined time period has elapsed; a performance drift limit of the ML model has been exceeded; a replacement ML model, based on the ML model profile, has been generated; or a popularity of the associated ML model, decreases below a threshold popularity.

In some embodiments, the network entity is selected from the list of network entities consisting of: an ADRF; a data repository function; a ML repository function; and another logical function.

In some embodiments, each ML model profile comprises one or more characteristic selected from the list of characteristics consisting of: a learning characteristic relating to analytics types; an algorithm type used to produce or train the first ML model; a network environment, network configuration, or network abstraction, for a geographical area containing data sources used in a training of the first ML model; a training time or schedule of training of the first ML model; a training data used in a training of the first ML model; a model characteristic of the first ML model; an operating hardware of the first ML model; an interoperability characteristic of the first ML model; and a version characteristic or evolution history of the first ML model.

In some embodiments, the interoperability characteristic comprises one or more of: a hardware interoperability characteristic; a software interoperability characteristic; a vendor platform interoperability characteristic; and a vendor information interoperability characteristic.

FIG. 7 illustrates an embodiment 700 of an alternative, method, in a wireless communication network. The method 700 comprises storing 710 a plurality of ML model profiles of respective ML models, wherein: each respective ML model has been trained using training data acquired from the wireless communication network when the wireless communication network was in a respective particular network condition; each respective ML model profile comprises at least one model characteristic of the respective ML model; each respective ML model profile comprises at least one network condition parameter indicative of the respective particular network condition; wherein each respective ML model profile has an associated unique ML model identifier that can be used by a consumer to uniquely identify the respective ML model profile.

In certain embodiments, the method 700 may be performed by a processor executing program code, for example, a microcontroller, a microprocessor, a CPU, a GPU, an auxiliary processing unit, a FPGA, or the like.

Some embodiments comprise receiving, from the consumer, a request for a required ML model, the request comprising: an ML model identifier, an ML model profile, and/or an ML model category; obtaining the required ML model and associated ML model profile having the ML model identifier, ML model profile and/or ML model category; and transmitting, to the consumer, the required ML model and ML model profile.

The requests may originate from an MTLF as a consumer of ML model profiles, or another consumer of ML models and/or ML model profiles.

Some embodiments comprise receiving, from the consumer, a storage request, the storage request comprising either a new ML model profile and an associated model identifier, or, an updated ML model profile and associated ML model identifier; and updating, based on the storage request, the plurality of ML model profiles with either the new ML model profile and model identifier, or with the updated model profile and associated model identifier.

Some embodiments comprise deleting, from the plurality of ML model profiles, an ML model profile and respective ML model identifier, when the ML model profile is identified as outdated.

Some embodiments comprise identifying an ML model profile as outdated when a predetermined time period has elapsed; a performance drift limit of the ML model has been exceeded; a replacement ML model, based on the ML model profile, has been generated; or a popularity of the associated ML model, decreases below a threshold popularity.

In some embodiments, the network entity is selected from the list of network entities consisting of: an ADRF; a data repository function; a ML repository function; and another logical function.

In some embodiments, each ML model profile comprises one or more characteristic selected from the list of characteristics consisting of: a learning characteristic relating to analytics types; an algorithm type used to produce or train the first ML model; a network environment, network configuration, or network abstraction, for a geographical area containing data sources used in a training of the first ML model; a training time or schedule of training of the first ML model; a training data used in a training of the first ML model; a model characteristic of the first ML model; an operating hardware of the first ML model; an interoperability characteristic of the first ML model; and a version characteristic or evolution history of the first ML model.

In some embodiments, the interoperability characteristic comprises one or more of: a hardware interoperability characteristic; a software interoperability characteristic; a vendor platform interoperability characteristic; and a vendor information interoperability characteristic.

Furthermore, the disclosure herein provides for a consumer entity in a wireless communication network, the consumer entity comprising a memory and a processor coupled to the memory, wherein the processor causes the consumer entity to transmit a request for a required ML model, the request comprising: an ML model identifier, an ML model profile, and/or an ML model category. In some embodiments, the processor causes the consumer entity to receive the required ML model and/or ML model profile. The ML model identifier and ML model profile are those as hereinbefore described. Furthermore, the request may be transmitted to an ADRF; a data repository function; a ML repository function; or another logical function.

FIG. 8 illustrates an embodiment 800 of ML model creation and storage. The embodiment 800 includes an NWDAF MTLF 820, a DCCF/MFAF 830, a NRF 840 and an ADRF 850.

In a first step 801, NWDAF MTLF 820 provides training to the ML Model(s). In addition, it creates a temporary ML Model profile based on information collected during the training phase and with the assistance of OAM, which may provide network environment information for the geographical area that contains data sources used for training.

Once the ML Model profile is completed, the NWDAF 820 needs to check if it is already included in the ADRF 850, or it is a new ML Model profile that also requires a unique ML Model ID.

In a subsequent step 802, NWDAF MTLF 820 issues a search request (Nnrf_MLModel_SearchRequest) to the NRF 840 to identify NFs that include ML profiles in general or a ML profile for a specific Analytics IDs or NFs that contain a specific ML Model Profile type or category.

In a subsequent step 803, NRF 840 responds with (Nnwdaf_MLModel_SearchRequestResponse) providing NF IDs if there was a matching (considering the ML Model profile or categories), the ML Model ID or ML Model ID set.

In a subsequent step 804, the NWDAF 820 uses the received ML Model ID or ML Model ID set and requests from a specific ADRF 850 either directly (Nadrf_MLModel_Requests) or via the DCCF/MFAF the corresponding ML Model profiles.

In a subsequent step 805, the ADRF 850 then responds to the NWDAF 820 (Nnwdaf_MLModel_RequestsResponse) with the ML Model ID and associated ML Model profile, directly, or via the DCCF/MFAF 830.

In a subsequent step 806, the NWDAF 820 then correlates (or checks the resemblance-based on a resemblance factor) the received profiles with the one newly produced, considering the respective attributes.

If the profiles are significantly different, then there is a need to create a newly unique ML Model ID before storing it to ADRF 850.

Otherwise, if the correlated ML Models share the same characteristics (i.e., have high resemblance), it can check if the newly created ML Model generalizes (i.e., performs well using different input data) using the validation/testing data related to the ML Model retrieved from ADRF 850. If the new ML Model generalizes then the NWDAF 820 may introduce some small updates (related to, e.g., the version, time and any other attribute that is different).

Note that a ML Model generalizes if it can validate/test successfully both the sample data stored with the ML Model that was retrieved and the validation/testing data sets created based on the newly collected data at the time of training from the data sources contained in the area of interest.

For example: A ML Model for predicting the NF load, e.g., UPF, can be selected from ADRF 850 to be used for training in MTLF 820 for UPF load prediction in a different geographical area. Such selection can be performed when ML Model profiles have high resemblance on, e.g., the network topology density, and/or type of connectivity, and/or average load/energy, and/or fault characteristics. The selected ML Model will then be trained using data from the sources contained in the new geographical area and may be under (slightly) different network service conditions, e.g., for a different slice, and/or for different UE conditions, e.g., for UEs with different mobility type or a different percentage of PDU sessions or applications. If the ML Model generalizes, i.e., can perform well considering both originally stored and new obtained validation/testing data sets, then the MTLF 820 can update its ML Model profile adding e.g., the new network context where the ML Model additionally performed well. Then it can optionally update NF ID for the updated ML Model in the NRF 840 (if multiple ADRF entities are contained in the PLMN) and/or the relevant ADRF 850 respectively.

If the correlated ML Models are identical then the NWDAF 820 takes no action.

The resemblance factor can be defined as the degree of similarity among the number of different attributes among two ML Models, i.e., two ML Models with a pre-determined number of same attributes can be characterized as having a high resemble factor; the mean absolute deviation among each attribute of two ML Models is below a pre-determined range; or a combination thereof.

In a subsequent step 807, the NWDAF 820 assigns a new ML Model ID if the created ML Model profile is different. Otherwise, in case the correlated ML Models share the same characteristics, i.e., have a high resemblance factor, and the new ML Model generalizes the NWDAF 820 prepares the corresponding updates of the ML Model profile.

In a subsequent step 808, the NWDAF 820 provides a storage request of the ML Model ID and ML Model profile towards the ADRF 850. This is illustrated as Nadrf_MLModel_StorageRequest and as comprising the new ML Model ID, ML model profile/update ML model profile.

In a subsequent step 809, the ADRF 850 stores the new and/or updated ML Model ID and ML Model profile.

In a subsequent step 810, the ADRF 850 issues a storage request response to the NWDAF 820. This is illustrated in the figure as Nadrf MLModel_StorageRequestResponse.

In a subsequent step 811, and optionally, (i.e., only in case the multiple NFs that contain an ML Model exist in the PLMN and the NRF 840 provides NF specific ML Model Profile type or category information) the NWDAF 820 provides an update for the ADRF ID related to the ML Model ID and ML Model profile, to the NRF 840. This is illustrated as Nnrf_NFManagement_NFUpdate and as comprising the ADRF ID, ML Model ID, ML Model profile.

In a subsequent optional step 812, the NRF 840 registers the ML model if multiple NFs that contain ML model information exist in the PLMN. This is illustrated as the NRF 840 storing ML Model ID, ML Model profile in the NRF 840.

In a subsequent step 813, the NRF 840 issues an update response to NWDAF 820. This is illustrated as Nnrf_NFManagement_NFUpdateResponse. In case the NRF 840 contains only the NFs that have ML Model profile capability, without storing the details of the ML profile then the steps 811-813 are skipped and not needed.

In a subsequent step 814, in the case that a ML Model is already included in the ADRF 850, it is discarded when it is no longer needed. A ML model is no longer needed in ADRF 850 when is outdated, i.e., used beyond a specific time limit or when a certain performance drift is obtained. A ML Model is characterized as outdated: by introducing a specific time instance or time window/duration that may be pre-configured by the MNO, e.g., for a specific event-outdoor concert duration session; when a performance drift is observed with a high frequency rate, i.e., beyond a pre-configured limit, once validating and/or testing a new ML Model that is created using a specific stored ML Model obtained from ADRF 850; when a stored ML Model obtained from ADRF 850 is used for creating a new ML Model and has a high possibility of creating a new ML Model with (i) a performance drift beyond a pre-configured limit and/or (ii) an expected prediction potential (considering the given KPIs) below a pre-configured limit; when the popularity rate drops below a pre-determined limit considering the number of hits a certain ML Model got for a certain time duration.

Current proposals are introducing the capability of storing ML Models i.e., for re-training and inference, and taking care of their life-cycle management, in ADRF. However, there is gap on identifying a stored ML Model uniquely in a PLMN. In addition, there is no means to examine whether an existing ML Model can generalize, i.e., be able to handle well, once different conditions arise or there is a need for a new ML Model. Finally, there is a need to keep track of the ML Model training history, i.e., backtrack which ML Model was used, and which network and computing conditions can be associated with each ML Model.

The disclosure herein relates to an apparatus that introduces a unique identifier across the PLMN for each ML Model that is verified against existing ML Models considering the ML Model profiles. A ML Model profile characterizes the ML Model training and inference conditions in an abstract manner that can be shared with 3^{rd} parties if needed, while it also keeps track of the training history. ML Model IDs shall be unique to avoid overpopulating the ADRF with ML Models that can handle the same conditions. The disclosure herein also introduces a method that examines whether a ML Model can generalize to handle different network conditions.

Current proposals introduce a ML Model ID bind to the NWDAF that provided the training, a process that may overpopulate the ADRF with the ML Models that can be used under the same conditions. They lack a verification step that ensures an ML Model is unique and they do not even examine if an existing ML Model in ADRF may benefit re-training process and/or can generalize considering the new training conditions. The current proposal also introduces a ML Model profile that abstracts network state conditions and captures further details, i.e., not previously considered, related to the usage of the ML Model and the training history.

More specifically, there disclosure herein provides for ML Model storage request and retrieval from ADRF. An NWDAF MTLF can check and store in ADRF unique ML Models or update an existing ML Model profile if it generalizes on new training conditions.

The disclosure herein also provides for ML model discovery, i.e., ML Models contained to an NF from NRF. An NWDAF MTLF registers a new NF with ML Model capabilities or ML Model to the ADRF and ADRF updates its NF ID info to the NRF and/or updates ML Model profile reflecting the new training and usage conditions.

The disclosure herein also provides for an NRF providing a list of ADRF IDs that contain the ML model category or ML model profile.

There is provided an apparatus and a method for profiling a ML model, the method comprises determining a first ML model profile, wherein the ML model profile comprises a plurality of model characteristics, at least one network condition parameter or a combination thereof.

In some embodiments the apparatus and method introduce a unique identifier to an ML Model, that is associated with a ML profile that holds the network conditions related to training and the ML Model inference characteristics, both of which are used to check and verify that an ML Model is unique in the PLMN.

In some embodiments of the apparatus and method, the ML Model profile contains one or more characteristic related to ML Model training and/or inference processes including learning characteristics, algorithm type characteristics, network environment, configuration management characteristics, time and/or schedule characteristics related to model training, data characteristics, model characteristics, hardware characteristics for running the model or inference, interoperability characteristics and/or version characteristics that reflect the evolution history of the model.

In some embodiments, the apparatus and method takes care of the ML Model life-cycle management including creating, updating, and deleting a ML Model and its corresponding profile and ID from a discovery and/or storage base.

In some embodiments, the apparatus and method can assist in obtaining ML model information held in a storage based on the ML model ID and/or the ML model profile; checking whether ML Models share the same characteristics based on a resemblance and/or resemble factor; checking whether an existing model held in a storage can generalize or needs to be updated to generalize once different conditions arise, considering the information provided by one or more existing ML Model profiles.

In some embodiments, the apparatus and method checks and/or updates a ML Model profile; provided that different ML profiles are compatible in terms of the vendor information; considering time specific information associated with each ML Model profile In some embodiments of the apparatus and method, different ML profiles are created to support different: usage in terms of the ML model characteristics or any combination thereof; deployment characteristics considering hardware, software, and platform or any combination thereof.

Some embodiments of the apparatus and method, assures that a data and/or model storage base or equipment is not overpopulated: with ML models that can handle the same analytics, network, and computing conditions; with ML models that are outdated considering time related limits or performance conditions

Some embodiments of the apparatus and method assure that the ML Model profile is populated with information that contains no network internals and can be shared with untrusted 3^{rd} parties.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3^{rd} Generation Partnership Project; 5G, 5th Generation of Mobile Communication; AI/ML, Artificial Intelligence/Machine Learning; ADRF, Analytical Data Repository Function; AF, Application Function; AnLF, Analytics Logical Function; API, Application Protocol Interface; DCCF, Data Collection Coordination Functionality; DNN, Data Network Name; eMBB, enhanced Mobile Broadband; KPI, Key Performance Indicator; MDT, Minimization of Driving Test; MF, Management Function; MFAF, Messaging Framework Adaptor Function; mIoT, massive Internet of Things; MNO, Mobile Network Operator; MnS, Management Service; MTLF, Model Training Logical Function; NF2, Network Function; NRF, Network Repository Function; NWDAF, Network Data Analytics Function; OAM, Operations, Administration and Maintenance; PM, Performance Measurement; UDM, User Data manager; UDR, User Data Repository; UE, User Equipment; URLLC, Ultra Reliable Low Latency Communications; and V2X, Vehicular to Everything.

1. A network entity in a wireless communication network, comprising:
at least one memory; and
at least one processor coupled with the at least one memory and configured to cause the network entity to:
determine a first machine learning (ML) model profile of a first ML model, wherein:
the first ML model has been trained using training data acquired from the wireless communication network when the wireless communication network was in a first particular network condition;
the first ML model profile comprises at least one model characteristic of the first ML model; and
the first ML model profile comprises at least one network condition parameter indicative of the first particular network condition.

2. The network entity of claim 1, wherein the at least one processor is further configured to cause the network entity to:
determine whether the first ML model profile is a new ML model profile of the wireless communication network; and
generate a unique first ML model identifier associated with the first ML model profile based on a determination that the first ML model profile is a new ML model profile.

3. The network entity of claim 2, wherein, to determine whether the first ML model profile is a new ML model profile, the at least one processor is configured to cause the network entity to:
retrieve, from a second network entity, at least a second ML model profile having an associated second ML model identifier, wherein:
the second ML model has been trained using training data acquired from the wireless communication network when the wireless communication network was in a second particular network condition;
the second ML model profile comprises at least one model characteristic of the second ML model; and
the second ML model profile comprises at least one network condition parameter indicative of the second particular network condition; and
compare the first ML model profile to the second ML model profile to determine a resemblance.

4. The network entity of claim 3, wherein the second network entity includes:
an analytical data repository function (ADRF);
a data repository function; or
a ML repository function.

5. The network entity of claim 3, wherein the at least one processor is further configured to cause the network entity to compare the first ML model profile to the second ML model profile based on a resemblance factor.

6. The network entity of claim 5, wherein the resemblance factor comprises a degree of similarity among attributes of the first and second ML models, including a degree of similarity of:
a quantity of said attributes; or
a mean absolute deviation of one or more of the attributes of the first ML model from the corresponding one of more attributes of the second ML model.

7. The network entity of claim 5, wherein the at least one processor is further configured to cause the network entity to:
determine a high resemblance when the resemblance factor satisfies a first predetermined resemblance criterion; and
determine a low resemblance and that the first ML model profile is new when the resemblance factor does not satisfy the first predetermined resemblance criterion.

8. The network entity of claim 7, wherein, when the high resemblance is determined, the at least one processor is further configured to cause the network entity to:
retrieve validation data related to the second ML model profile; and
determine whether the first ML model generalizes to the validation data by applying the validation data to the first ML model.

9. The network entity of claim 8, wherein the at processor is further configured to cause the network entity to:
update the second ML model profile when the first ML model generalizes to the validation data.

10. The network entity of claim 9, wherein the at least one processor is further configured to cause the network entity to:
transmit a storage request to the second network entity, wherein the storage request comprises:
the first ML model identifier and first ML model profile when the first ML model profile has been determined to be new; or
the second ML model identifier and the updated second ML model profile when the high resemblance has been determined.

11. The network entity of claim 3, wherein, to retrieve from the second network entity the at least a second ML model profile having an associated second ML model identifier, the at least one processor is further configured to cause the network entity to:
transmit a search request to a repository or a network repository function, the search request comprising a request for a network entity having an ML model profile matching the first ML model profile or having a requested ML model profile category;
receive a search response from the repository or the network repository function, the search response comprising:
a network entity identifier of the second network entity wherein the second network entity has ML model profiles matching the first ML model profile, the search response further comprising ML model identifiers associated with the matched ML model profiles; or
a network entity identifier of the second network entity wherein the second network entity has the requested ML model profile category, the search response further comprising an ML model profile set identifier;
transmit, to the second network entity, a request for the at least a second ML model profile, the request comprising the ML model identifiers or ML model profile set identifier; and
receive, from the second network entity, the at least a second ML model profile and associated ML model identifiers.

12. The network entity of claim 1, wherein the at least one processor is further configured to cause the network entity to:
train the first ML model; and
determine the first ML model profile based at least on information collected or determined during the training.

13. The network entity of claim 1, wherein the at least one processor is further configured to cause the network entity to:
determine the first ML model profile based at least on information retrieved from an operations, administration and maintenance (OAM) function.

14. The network entity of claim 1, wherein the first ML model profile comprises one or more characteristics, including:
a learning characteristic relating to analytics types;
an algorithm type used to produce or train the first ML model;
a network environment, network configuration, or network abstraction, for a geographical area containing data sources used in a training of the first ML model;
a training time or schedule of training of the first ML model;
a training data used in a training of the first ML model;
a model characteristic of the first ML model;
an operating hardware of the first ML model;
an interoperability characteristic of the first ML model; or
a version characteristic or evolution history of the first ML model.

15. The network entity of claim 14, wherein the interoperability characteristic includes:
a hardware interoperability characteristic;
a software interoperability characteristic;
a vendor platform interoperability characteristic; or
a vendor information interoperability characteristic.

16. The network entity claim 1, wherein the at least one network condition parameter is abstracted away from network information internals of the wireless communication network.

17. The network entity of claim 1, wherein the network entity is a model training logical function.

18. The network entity of claim 1, wherein the wireless communication network is a public land mobile network (PLMN).

19. A network entity in a wireless communication network, comprising:
at least one memory; and
at least one processor coupled with the at least one memory and configured to cause the network entity to:
store, in the at least one memory, a plurality of machine learning (ML) model profiles of respective ML models, wherein:
each respective ML model has been trained using training data acquired from the wireless communication network when the wireless communication network was in a respective particular network condition;
wherein each respective ML model profile comprises at least one model characteristic of the respective ML model;
wherein each respective ML model profile comprises at least one network condition parameter indicative of the respective particular network condition; and
wherein each respective ML model profile has an associated unique ML model identifier usable by a consumer to uniquely identify the respective ML model profile.

20.-26. (canceled)

27. A method performed by a network entity, the method comprising:
determining a first machine learning (ML) model profile of a first ML model, wherein:
the first ML model has been trained using training data acquired from a wireless communication network when the wireless communication network was in a first particular network condition;
wherein the first ML model profile comprises at least one model characteristic of the first ML model; and
wherein the first ML model profile comprises at least one network condition indicative of the first particular network condition.

28.-31. (canceled)
